(19) United States
(12) Patent Application Publication
(10) Pub. No.: US 2015/0142460 A1
(43) Pub. Date: May 21, 2015

(54) METHOD AND SYSTEM FOR ORDERING AND ARRANGING A DATA SET FOR A SEVERITY AND HETEROGENEITY APPROACH TO PREVENTING EVENTS INCLUDING A DISEASE STRATIFICATION SCHEME

(71) Applicant: Allegheny-Singer Research Institute, Pittsburgh, PA (US)

(72) Inventor: Mark Doyle, Wexford, PA (US)

(21) Appl. No.: 14/400,941

(22) PCT Filed: May 23, 2013
(86) PCT No.: PCT/US13/42462

§ 371 Date: Nov. 13, 2014

Related U.S. Application Data
(60) Provisional application No. 61/651,114, filed on May 24, 2012.

(51) Int. Cl. G06F 19/00

(52) U.S. Cl. CPC G06F 19/345; G06F 19/3431
USPC 705/2

(57) ABSTRACT

A method and system for ordering and arranging a data set. The data set is initially accessed, the data set including includes a set of diagnostic test values and one or more outcomes for each of a plurality of patients. A first and second patient data set is retrieved from the data set. A first set of diagnostic test values are selected from the first patient data set, and a second set of diagnostic text values are selected from the second patient data set. The diagnostic test values are normalized and ordered, and equations are created describing the normalized and ordered test values. A processing device compares the created equations to determine a treatment plan for the first patient based upon determined similarities to the second patient.

### CROSS REFERENCE TO RELATED APPLICATION

This application is a national stage application of, and claims priority to, International Patent Application No. PCT/US2013/042462, filed May 23, 2013, which in turn claims priority to U.S. Provisional Application No. 61/651,114 filed May 24, 2012 entitled “Method and System for Ordering and Arranging a Data Set for a Severity and Heterogeneity Approach to Preventing Events Including a Disease Stratification Scheme,” the content of which is hereby incorporated by reference in its entirety.

### BACKGROUND

Many professions rely on the decisions of skilled professionals in order to yield successful results. For example, during almost every patient visit, medical professionals must make decisions regarding whether or not to require a particular course of action for the patient. Based on the results of a test, a physician will typically decide whether to order additional tests, whether to recommend a course of treatment, or whether to maintain the status quo. In highly complex professions such as medicine, professionals may be faced with a vast quantity of data and have difficulty determining which of the data is relevant to a decision.

When a patient is suspected of having a type of disease, e.g. heart disease or cancer, the clinical issues become finding the sub-type of disease and recommending the optimal treatment plan. Examples of a disease sub-type for heart disease might be a patient with valvular disease or a patient with stenotic coronary arteries, each requiring different and unique treatment plans. For each suspected disease type, the patient typically undergoes a series of diagnostic tests. In some instances, the series of tests are designed to eliminate patients from undergoing the most expensive or most invasive test, i.e., if the “lower order” tests do not detect the presence of the disease sub-type, then the patient will not progress through the full series of tests. For a patient suspected of coronary artery disease, coronary artery catheterization is regarded by some as the definitive test (i.e. the “gold standard”), but the patient will typically undergo several blood level tests and a myocardial perfusion test prior to catheterization. Only if the patient exhibits sufficient evidence of disease on these lower order tests will they progress to a catheterization suite of tests.

When the catheterization test is performed, the lower order test results are often discounted as the catheterization test is regarded as the gold standard in this example, thus resulting in the wasted expense for the discounted tests incurred by the patient or the patient's insurer. However, there are several drawbacks to this approach: 1) the lower order tests may miss disease, and thus cause treatment to be withheld; 2) even the gold standard test may misdiagnose patients as having too low a level of disease to treat effectively; 3) the results from the lower order tests often do not contribute to the further management of the patient after the gold standard test is performed; 4) often, if the suspicion of disease is high, not all the lower order tests are performed, again discounting their ability to contribute to further patient management; and 5) it is quite typical for many patients to have similar values of several lower order tests, e.g. systolic blood pressure and blood cholesterol levels in some mildly unfavorable range, and for it to be observed that the patients experience different outcomes despite these similarities.

Additionally, treatment of patients is governed by evidence-based approaches typically overseen by professional bodies. However, the guidelines for initiating treatment are typically based on population averages, and thus some patients are over-treated, and are at risk of experiencing adverse side effects. Conversely, some patients are under-treated, and thus are at risk of suffering a severe adverse outcome that may have been treatable if the patients were properly treated. The typical paradigm for making decisions of when to initiate treatment are based on the patient attaining a certain extent of disease, e.g., reaching a systolic blood pressure of 140 mmHg, reaching a blood lipid level of 100, or having other similar test results that may indicate an extent of a disease. However, as discussed above, professionals may be faced with a vast quantity of data and have difficulty determining which of the data is relevant to a decision related to disease extent, and thus may be prone to misdiagnosing and fail to deliver a proper level of treatment.

### SUMMARY

In one general respect, a first embodiment discloses a method for ordering and arranging a data set. The method includes accessing a data set of patient data, wherein the data for each patient includes a set of diagnostic test values and one or more outcomes; retrieving, from the data set, a first patient data set that corresponds to a first outcome; selecting a first set of the diagnostic test values from the first patient data set; normalizing the first set of diagnostic test values to cover a range; ordering the normalized first set of diagnostic test values such that a low-frequency content plot is derived; creating a first equation describing the ordered data of the first patient data set for the normalized first set of diagnostic test values; retrieving, from the data set, a second patient data set that corresponds to a second outcome; selecting, a second set of diagnostic test value from the second patient data set; normalizing the second set of diagnostic test values to cover a range; ordering the normalized second set of diagnostic test values; creating a second equation describing the ordered data of the second patient data set for the normalized second set of diagnostic test values; and comparing the first and second equations.

In another general respect, a second embodiment discloses a system for ordering and arranging a data set. The system includes a processing device and a non-transitory computer readable medium operably connected to the processor, the computer readable medium containing a set of instructions. The instructions are configured to cause the processing device to access a data set of patient data, wherein the data for each patient includes a set of diagnostic test values and one or more outcomes; retrieve, from the data set, a first patient data set that corresponds to a first outcome; select a first set of the diagnostic test values from the first patient data set; normalize the first set of diagnostic test values to cover a range; order the normalized first set of diagnostic test values such that a low-frequency content plot is derived; create a first equation describing the ordered data of the first patient data set for the normalized first set of diagnostic test values; retrieve, from the data set, a second patient data set that corresponds to a second outcome; select a second set of diagnostic test value from the second patient data set; normalize the second set of diagnostic test values to cover a range; order the normalized second set of diagnostic test values; create a second equation describing the ordered data of the second patient data set for the normalized second set of diagnostic test values, and compare the first and second equations.

### BRIEF DESCRIPTION OF THE DRAWINGS

FIG. 1a illustrates a time ordered sampling of a sinusoidal waveform.

FIG. 1b illustrates a random sampling of a sinusoidal waveform.

FIG. 1c illustrates a time ordered sampling of a sinusoidal waveform including interpolated data points.

FIG. 2 illustrates an ordered sampling of various disease components according to an embodiment.

FIG. 3 illustrates an ordered sampling of various disease components for two groups overlaid on the same plot.

FIG. 4 illustrates a hierarchal representation of disease levels according to an embodiment.

FIG. 5 illustrates a sample radar plot for illustrating various disease components according to an embodiment.

FIG. 6 illustrates a corresponding set of radar plots for two groups of patients.

FIG. 7 illustrates a corresponding set of normalized radar plots for two groups of patients according to an embodiment.

FIG. 8 illustrates a flowchart showing a process for determining and displaying two or more plots according to an embodiment.

FIG. 9 illustrates various elements of a computing device for implementing various methods and processes described herein.

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to.” As used in this document, the terms “sum,” “product” and similar mathematical terms are construed broadly to include any method or algorithm in which a single datum is derived or calculated from a plurality of input data.

As used herein, the term “modality” refers to a mode, process or method of obtaining a set of data. For example, a modality may include a specific medical test or imaging process wherein one or more sets of patient specific data are obtained.

Typically, when a human makes a decision, the person relies upon some set of known facts or concrete evidence. However, this set of known facts may not include all necessary information required to make the decision. Thus, the person must use some amount of judgment when making the decision.

One example of an area where a person such as a medical provider makes a decision without a full set of data is in determining disease sub-type and an associated treatment plan. Using the processes and techniques as taught herein, a medical provider may make a more informed decision as to an appropriate treatment plan for a patient.

This disclosure is complementary to prior processes DICE and DICIE as taught in the related U.S. patent application Ser. No. 13/289,335, the disclosure of which is hereby incorporated by reference, but is not dependent on such processes. The approach as taught herein, referred to as Severity and Heterogeneity Approach to Preventing Events (SHAPE) arranges data that forms part of the medical record of a patient in an order that allows characterization of that patient with regard to disease sub-type and severity, i.e., the ordered data forms a characteristic shape associated with each disease sub-type within the context of a hierarchical scheme or stratification the diseases.

By using the characterization scheme of SHAPE, derived from previously evaluated patient groups, a suitable treatment or treatment plan can be recommended for a current patient. Further, since the medical data are arranged in an ordered manner, and the plot of that data forms a characteristic shape, then there is the potential to eliminate some of the data and still adequately characterize the disease sub-type of the patient. This aspect either allows improved characterization of the patient in the absence of a complete set of diagnostic tests, or, more proactively, it allows an optimal selection of tests, with the aim of omitting the most expensive or invasive tests by design, thereby bringing additional economic benefit.

Typically, a patient is suspected of having a type of disease, e.g., heart disease or cancer, and the clinical issues then become finding the sub-type of disease and recommending the optimal treatment plan. Examples of a disease sub-type for heart disease might be a patient with valvular disease or a patient with stenotic coronary arteries, each requiring quite different treatment strategies. For each suspected disease type, the patient typically undergoes a series of diagnostic tests. In some instances, the series of tests is designed to eliminate patients from undergoing the most expensive or most invasive test, i.e., if the “lower order” tests do not detect the presence of the disease sub-type, then they will not progress through the full series of tests.

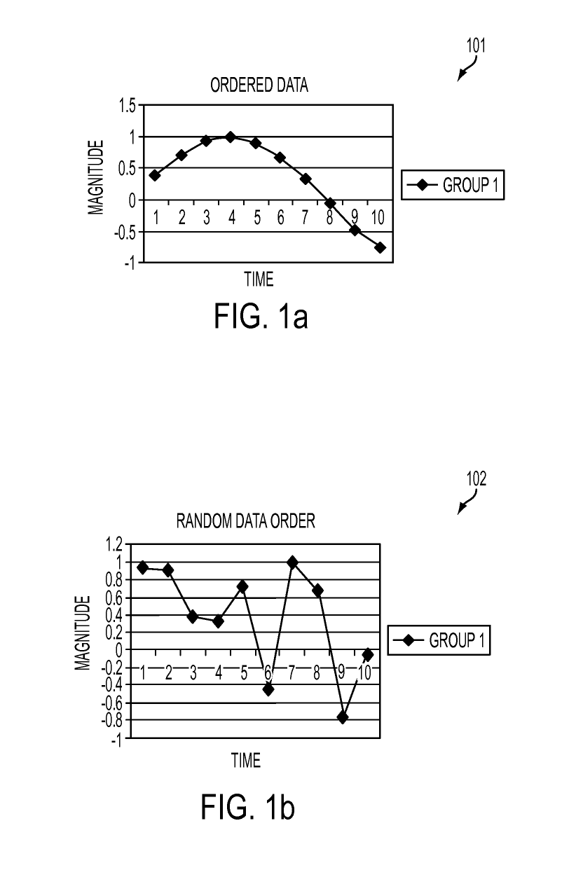

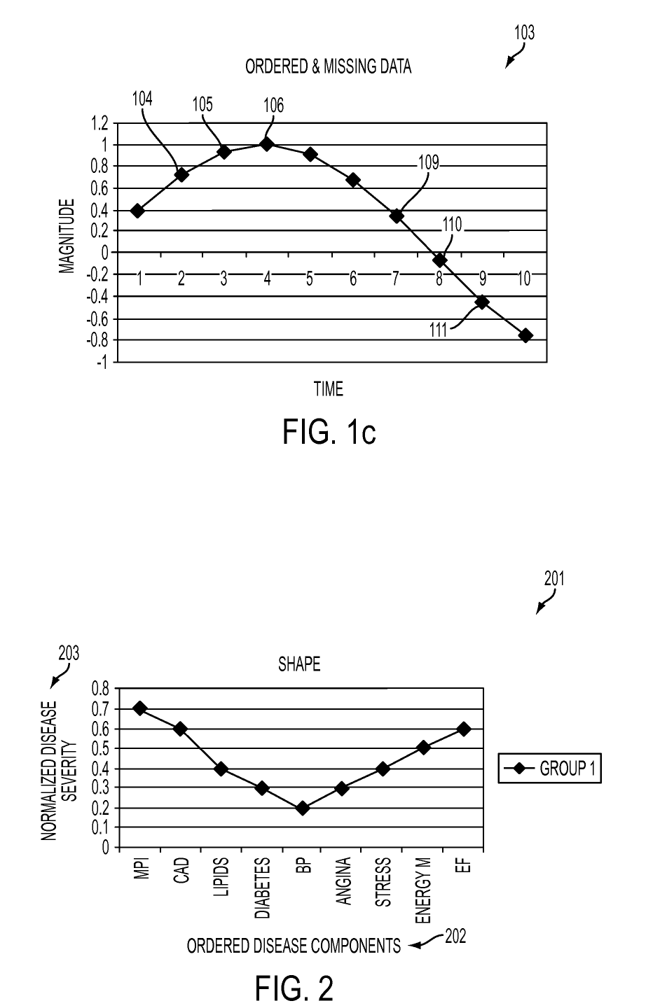

In the separate area of signal processing there is often the observation that ordering data in some logical manner better represents the data than a random presentation, and that this ordering of data helps reduce the number of variables needed to characterize the data. FIG. 1a illustrates a sampling 101 of a sinusoidal waveform. If the sampled data are time ordered, then describing the waveform can be done by using the parameters of frequency and amplitude, thereby fully and uniquely describing the multiple data points using only two parameters. Conversely, if the same data points were presented in a random manner, as shown in FIG. 1b, a resulting sampling 102 would not be easily characterized, and more importantly, a different arranging of the data would result in a different characterization, effectively invalidating any characterization that sought to simplify the data (i.e. reduce the number of variables describing the data).

Referring back to FIG. 1a (i.e., the sequentially time ordered data), if some limited number of data points were omitted, as shown in sample 103 illustrated in FIG. 1c, it may a simple matter to interpolate data on either side of the given points and derive the missing values with good accuracy. For example, data point 105 may be derived based upon an interpolation of know data points 104 and 106. Similarly, data point 110 may be derived based upon an interpolation of known data points 109 and 111. The ability to predict values may reflect the fact that the data is band-limited, i.e., there is an upper limit to the frequency of the data, which allows a lower sampling rate (i.e., can accommodate missing data) to adequately represent the full data set.

When determining diagnostic medical data, as indicated above, in common practice, the order in which medical tests are performed is governed by the expense and degree of invasiveness of the tests. Further, after a series of tests are performed, more clinical weight is attached to some tests over others, and much information is discarded at the stage of deciding a treatment course for the patient. In SHAPE, the medical data may be arranged in a logical order such that the band-width describing the data is limited and optionally minimized. In this way, less data (i.e., fewer tests) may be acquired or missing data may be accommodated. In one embodiment, the wide variety of data that is entered into SHAPE may be normalized into a common range (e.g. expressing the data using percentages of some physiologic range, such that data typically range from 0 to 100%). For instance, one of the input variables could be a DICE-augmented reading of a diagnostic test. The ordering of the data may be found at an initialization stage by exploration of historical data sets, especially if the treatment and patient outcome of those tests were known. Normalized data from multiple diagnostic tests may be ordered for each patient, and arranged until the shape described by the ordered plot of data underwent some minimization of bandwidth as described above. The data may be plotted graphically for easy human interpretation, but more importantly, the relationship between ordered data is known to the computer system and can be defined by an equation. For example, FIG. 2 illustrates an exemplary sample 201 showing a SHAPE ordered data set for a series of disease components 202 as normalized on a severity scale 203 ranging from 0 to 0.8. The disease components 202 may include, for example, myocardial perfusion imaging (MPI), coronary artery disease (CAD), blood lipid levels, diabetes, blood pressure (BP), angina, stress, energy model of the heart (energy M) and ejection function of the heart (EF). It should be noted the disease components 202 as shown in FIG. 2 are by way of example only.

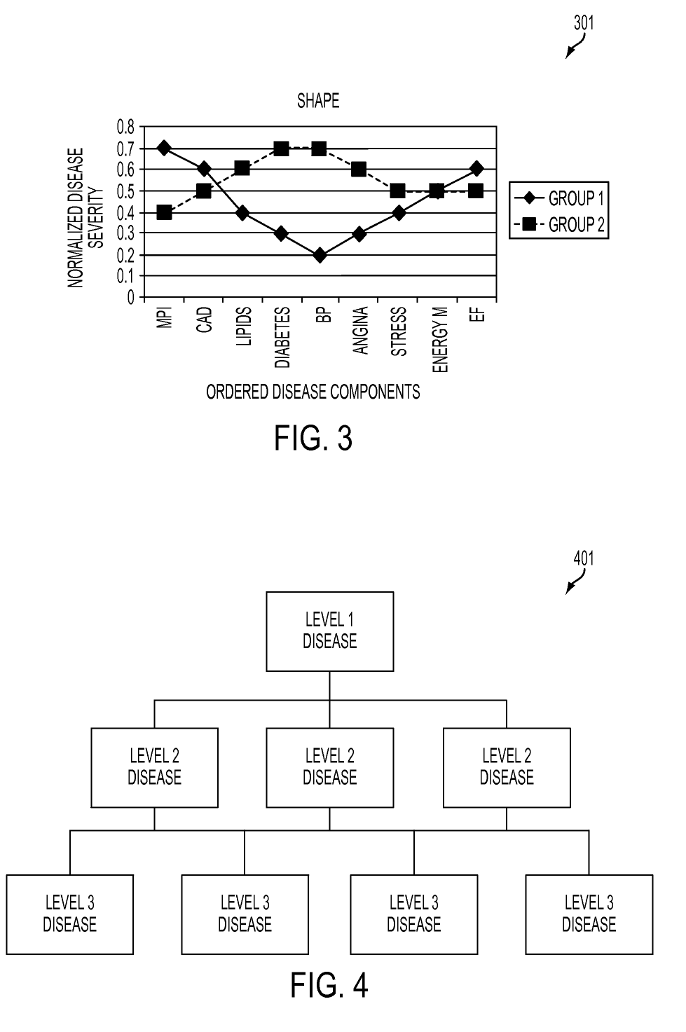

The ordering process may be repeated for similar data from multiple patients, until a consensus of ordering was achieved. The intention is that the ordering would identify several distinct groups of patients, each group having a distinct shape of the magnitude of ordered variables (as described by an equation obtained for example by a least-squares fitting criteria). From the observation of outcomes of patients, it would be expected that a patient with some characteristic data shape would experience better outcomes for one particular treatment compared to another applied to patients characterized by the same data shape of curve. FIG. 3 illustrates a sample 301 where two patient groups are overlaid on the same sample. In this example, both groups have similar CAD and energy model disease components. However, when looking at the entire sample of ordered data 301, each group is characterized by a distinctly difference shape, and thus may require distinctly difference treatments despite similarities in key physiologic variables. Also from this ordered representation of the data, it can be appreciated that to distinguish the two groups of patients, in the tests corresponding to the two points, if the curves cross each other can be omitted from consideration, since they do not provide differentiating data, and further they are not needed to complete the band-limited description of the two groups of patients.

After having made these observations and identified the patient groups and effective treatments, thereafter, the SHAPE ordering of data could be used to guide future therapy and better direct patients as to which diagnostic test would add the most value to characterize their disease sub-type.

Another aspect of the SHAPE tool for correctly determining a treatment plan may be to arrange diseases in a hierarchical scheme or to stratify the diseases. FIG. 4 illustrates an exemplary stratification 401 of an exemplary disease that allows clinical and patient management decisions to be modified based on the hierarchical ordering. To establish what the hierarchical relationships are may include investigation of clinical data sets during an initialization step. In a clinical data set, a medical practitioner may identify certain components of this hierarchical structure for cardiovascular disease. Establishing the components of the hierarchical structure may be simplified by use of prior art techniques such as DICE and DICIE (without use of these prior techniques, constructing a hierarchical ordering would typically require very large populations). The hierarchal scheme as described herein is directed toward the use of the hierarchical ordering of disease states in decision-making. By recognizing that there is a hierarchical structure for a particular disease may be used to alter the disease extent required before a treatment is initiated. For example, a patient displaying an absence of a level 1 disease state (e.g. no myocardial perfusion defect) may have medication prescribed only when the lipid levels (a level 2 disease state) reach a high extent, e.g. 150. Conversely, a patient with a level 1 disease state (e.g. a myocardial perfusion defect present) may have medication prescribed when the lipid levels (a level 2 disease state) reach a lower extent, e.g. 80. Further, the presence of a disease state at the same hierarchical level as elevated lipids (e.g. presence of diabetes) would not modify the threshold at which lipid reduction therapy is initiated.

The SHAPE and stratification techniques as discussed herein involve the ordering and hierarchal structuring of disease components associated with a major disease category, e.g., ischemic heart disease. These concepts may be intuitively represented in a one dimensional (1D) plot or a two-dimensional (2D) radar plot depending on preference. In the radar plot, any essential features may be retained in a visual representation of the data. The hierarchal nature of the data may be represented as a multiplication effect on the plot. Additionally, data may be further compressed by integrating the area in the radar plot.

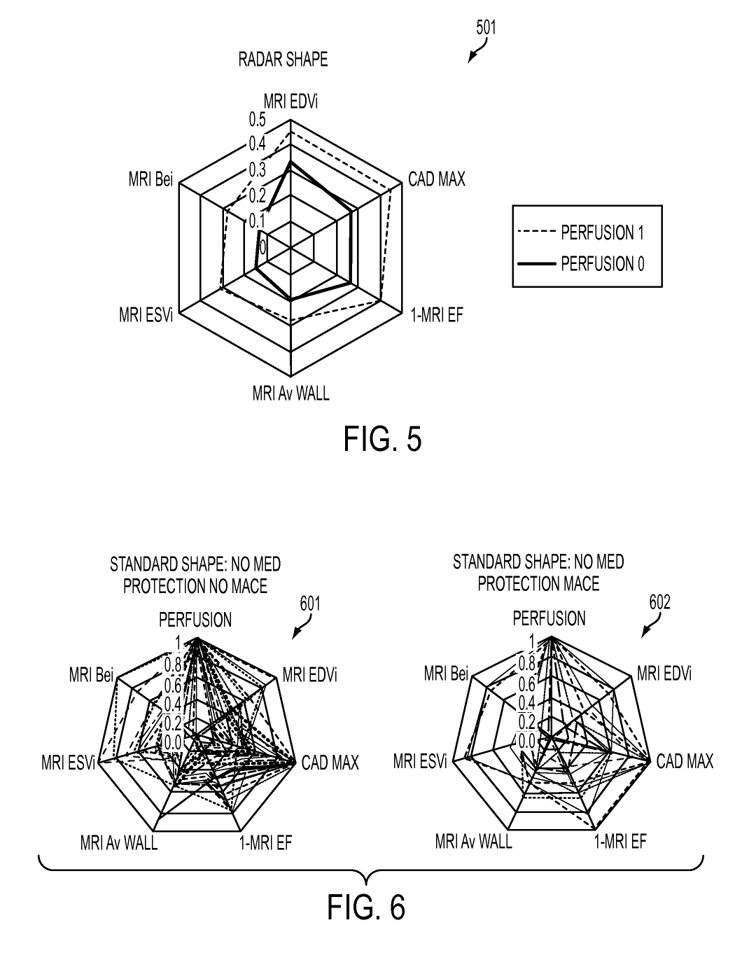

As shown in FIG. 3, two groups may be represented in a linear plot of the ordered SHAPE variables, the plot showing the differences between the two groups. As shown in FIG. 5, a 2D radar plot 501 may be used to represent the same two groups. The radar plot 501 may be used to identify patients who may benefit from medical protection via a treatment plan or other similar treatment technique. The occurrence of a major adverse cardiovascular event (MACE) may be concentrated in patients with a large SHAPE area (as determined by an integration of the area of the radar plot) and who are not on protective medicine.

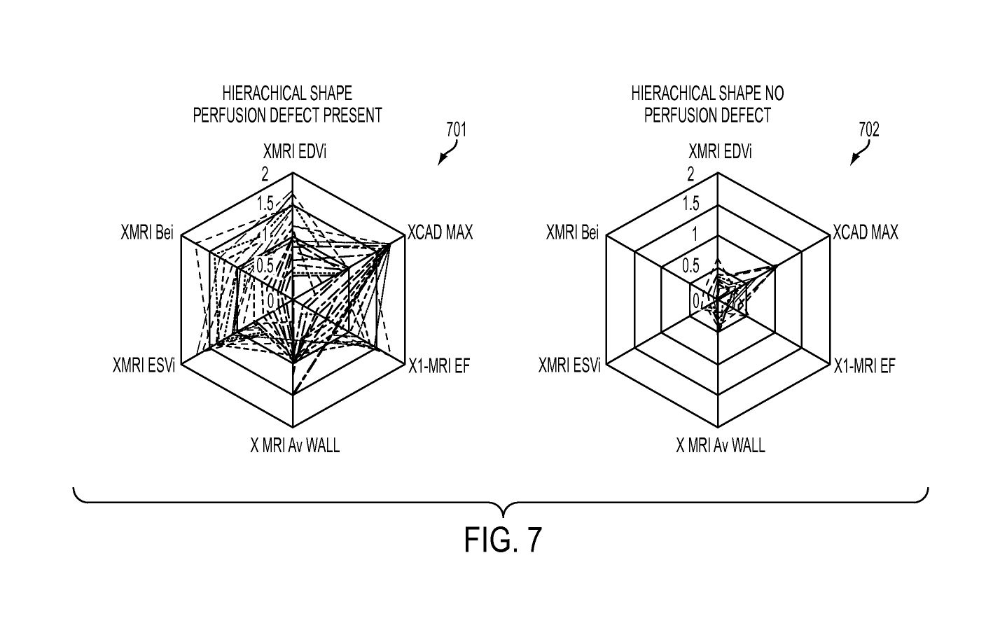

Occasionally, a radar plot for a particular group may be inconclusive based solely upon the SHAPE ordering of information. For example, as shown in FIG. 6, radar plot 601 represents a group of patients having no medical protection and who have not experienced a MACE. Conversely, radar plot 602 represents a group of patients that have no medical protection who have experienced a MACE. In both plots 601 and 602, the perfusion nodes are both close to 1. Thus, using perfusion as an indicator for these two groups may be inconclusive. However, and more fundamentally, as shown by the stratification of the medical data, there are hierarchal differences between these two groups. As such, the hierarchal stratification may be incorporated into the radar plots as a multiplication factor, rather than a node on the same plot.

For example, to calculate the multiplication factor, the following criteria may be used: (1) Incorporate the ratio of event rate between patients having a perfusion and those not having a perfusion. In this example, the ratio would be 0.17/0.04=4.6. (2) Incorporate the ratio of the mean area of the positive perfusion plots and the negative perfusion plots=2.6. (3) Determine the hierarchal factor by dividing the event rate ratio by the mean are ratio, 4.6/2.6=1.7. It should be noted these criteria are shown by way of example only.

By determining a multiplication factor, the process may allow for shifting and personalization of thresholds directed to individual patients for determining a treatment plan. FIG. 7 shows a set of resulting radar plots incorporating the determined multiplication factor. A plot 701 shows patients with a perfusion defect present and plot 702 shows patients with no perfusion defect. Patients who experienced a MACE have a high area in the hierarchal representation (graphically represented in the radar plot). Thus, by comparing a patient who has experienced a perfusion defect's information (either determined through various tests or through the SHAPE process as described above) to a radar plot such as plot 701, the likelihood of the patient experiencing a MACE may be quickly determined with a minimal set of data.

By visually presenting the SHAPE data in a radar or 1D plot, the data may indicate a certain dominant axis to the disease, as well as allowing overall severity of the disease to be visually identified. More importantly, this axis may be found by analysis of the equation describing the SHAPE ordered data. Further, the area of the radar plot may be integrated geometrically to identify disease severity. Additionally, the distribution of events among patients may be analyzed to determine high and low risk groups. For example, critical events may be experienced by patients with a hierarchal SHAPE plot area above 0.05. This threshold may indicate the level where, for patients below the threshold, there may be no impact in event occurrence for those on or off medication. For those above the threshold, there may be a dramatically higher percentage of those off medication experiencing a critical event than those on medication. Thus, the SHAPE ordering of data, combined with the stratification of the data into a hierarchal structure, summarizes the severity of each individual patient. This information may be optionally plotted into a 1D linear or 2D radar plot for visual presentation to the human. SHAPE ordering and stratification also provides a framework to compare groups of patients, such as those that may appear in a clinical study.

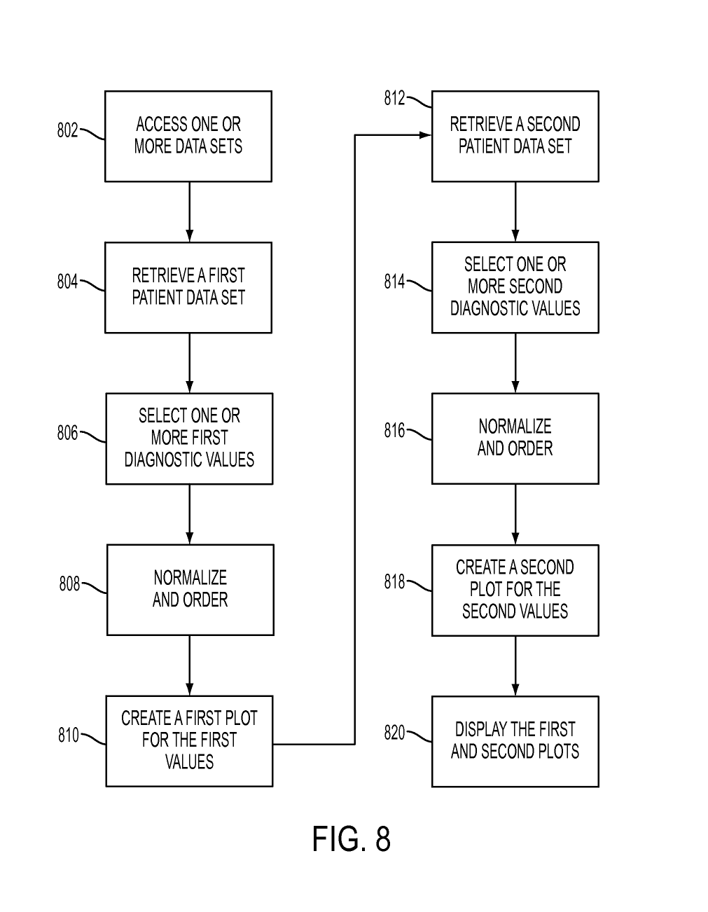

FIG. 8 illustrates a flowchart showing a process for performing the SHAPE and stratification processes as discussed above to provide a comparison ordering of data for further analysis. For example, a medical professional may use the process as illustrate in FIG. 8 to determine a treatment plan for an individual patient. The medical professional and/or a processor may access 802 one or more data sets. The data sets may include patient records, diagnostic values for each patient, treatment plans and one or more outcomes resulting from those treatment plans. The data sets may be represented as data listings, 1D representations such as the SHAPE samples shown in FIGS. 3 and 4, or may be stored in other similar data structures. From the accessed 802 records, the medical professional may retrieve 804 a data set related to a first group of patients that have achieved a first outcome. The medical professional and/or processor may select 806 one or more diagnostic values from the first patient data set and the processor may normalize the set of diagnostic values to cover a specific range (such as values of 0 to 1) and order 808 the normalized test results to derive the values for a low-frequency content plot such as one of those shown in FIG. 7. Optionally, the medical professional may further stratify the data set according to the hierarchal scheme as discussed above.

The processor may then create 810 a first plot for the first patient based upon the normalized and ordered diagnostic test results. As shown above, the first plot may be a 2D radar plot including a multiplication factor for normalizing the data shown therein.

In order to provide a means for comparing the first patient's information, the medical professional or processor may create 818 a similar second plot for a second patient's data set. Like before, the processor may retrieve 812 a data set related to the second patient and the second patient's present course of treatment. The medical professional and/or the processor may select 814 one or more diagnostic test results from the second patient data set and normalize and order 816 the second set of test results. Optionally, the system may further stratify the data set according to the hierarchal scheme as discussed above.

The processor may the create 818 the second plot for the second patient based upon the second patient set's ordered, normalized test results. The two plots may then be displayed 820 for comparison purposes, allowing the medical professional to evaluate and analyze the current treatment plan for the first patient based upon the historic records associated with the second patient.

It should be noted that while the process as illustrated in FIG. 8 is shown in a linear path, several of the steps may be performed simultaneously. For example, the medical professional may create both the first plot (810) and the second plot (818) simultaneously.

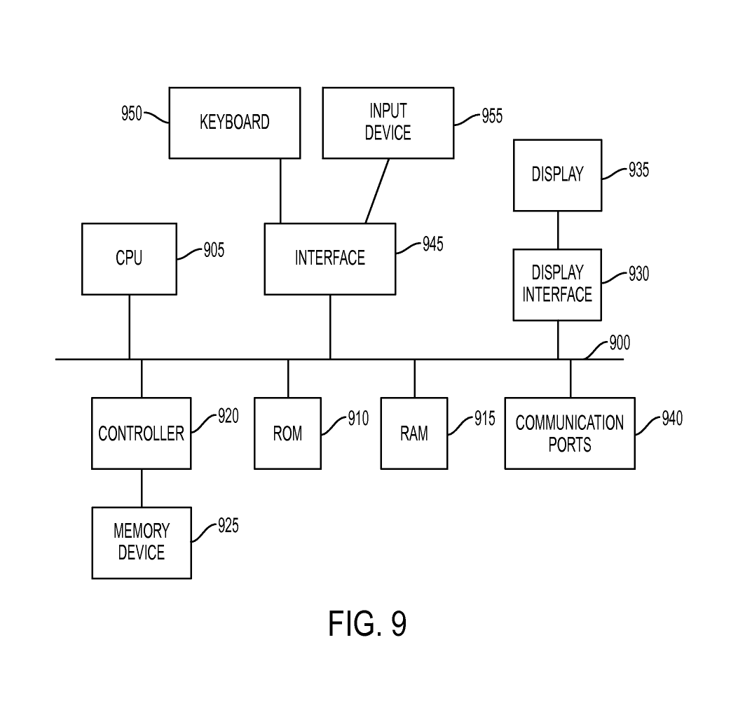

FIG. 9 depicts a block diagram of internal hardware that may be used to contain or implement various components to perform the processes illustrated in the previous figures. A bus 900 serves as the main information highway interconnecting the other illustrated components of the hardware. CPU 905 is the central processing unit of the system, performing calculations and logic operations required to execute a program. CPU 905, alone or in conjunction with one or more of the other elements disclosed in FIG. 9, is an illustration of a processing device, computing device or processor as such terms are used within this disclosure. Read only memory (ROM) 910 and random access memory (RAM) 915 constitute examples of memory devices.

A controller 920 interfaces with one or more optional memory devices 925 to the system bus 900. These memory devices 925 may include, for example, an external or internal DVD drive, a CD ROM drive, a hard drive, flash memory, a USB drive or the like. As indicated previously, these various drives and controllers are optional devices. Additionally, the memory devices 925 may be configured to include individual files for storing any software modules or instructions, auxiliary data, common files for storing groups of results or auxiliary, or one or more databases for storing the result information, auxiliary data, and related information as discussed above.

Program instructions, software or interactive modules for performing the processes as discussed above may be stored in the ROM 910 and/or the RAM 915. Optionally, the program instructions may be stored on a tangible computer readable medium such as a compact disk, a digital disk, flash memory, a memory card, a USB drive, an optical disc storage medium, and/or other recording medium.

An optional display interface 930 may permit information from the bus 900 to be displayed on the display 935 in audio, visual, graphic or alphanumeric format. The information may include information related various data sets. Communication with external devices may occur using various communication ports 940. A communication port 940 may be attached to a communications network, such as the Internet or an intranet.

The hardware may also include an interface 945 which allows for receipt of data from input devices such as a keyboard 950 or other input device 955 such as a mouse, a joystick, a touch screen, a remote control, a pointing device, a video input device and/or an audio input device.

Several of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

What is claimed is:

1. A method, comprising:
accessing, by a processing device, a data set of patient data, wherein the data for each patient includes a set of diagnostic test values and one or more outcomes;
retrieving from the data set, by the processing device, a first patient data set that corresponds to a first outcome;
selecting, by the processing device, a first set of the diagnostic test values from the first patient data set;
normalizing, by the processing device, the first set of diagnostic test values to cover a range;
ordering, by the processing device, the normalized first set of diagnostic test values such that a low-frequency content plot is derived;
creating, by the processing device, a first equation describing the ordered data of the first patient data set for the normalized first set of diagnostic test values;
retrieving from the data set, by the processing device, a second patient data set that corresponds to a second outcome;
selecting, by the processing device, a second set of diagnostic test value from the second patient data set;
normalizing, by the processing device, the second set of diagnostic test values to cover a range;
ordering, by the processing device, the normalized second set of diagnostic test values;
creating, by the processing device, a second equation describing the ordered data of the second patient data set for the normalized second set of diagnostic test values; and
comparing, by the processing device, the first and second equations.

2. The method of claim 1, wherein creating the first equation describing the ordered data comprises plotting the normalized first set of diagnostic test values.

3. The method of claim 2, wherein creating the second equation describing the ordered data comprises plotting the normalized second set of diagnostic test values.

4. The method of claim 3, wherein comparing the first and second equations comprises:
plotting the first equation and the second equation in a graph; and
displaying, on a display operably connected to the processing device, the graph.

5. The method of claim 2, further comprising, before plotting the normalized first set of diagnostic test values, stratifying the first plurality of normalized diagnostic test results by removing patient data for a diagnostic test having a patient data that exceeds a threshold, and adjusting remaining patient data by an adjustment factor.

6. The method of claim 1, further comprising determining a threshold value, wherein the threshold value is indicative of whether a patient is at high risk of suffering a severe event.

7. The method of claim 6, further comprising comparing a first risk score for the first patient against the threshold value.

8. The method of claim 7, wherein the first risk score is determined based upon an integration of an area of the first equation of the first patient data set.

9. A system comprising:
a processing device; and
a non-transitory computer readable medium operably connected to the processor, the computer readable medium containing a set of instructions configured to cause the processing device to:
access a data set of patient data, wherein the data for each patient includes a set of diagnostic test values and one or more outcomes,
retrieve, from the data set, a first patient data set that corresponds to a first outcome,
select a first set of the diagnostic test values from the first patient data set,
normalize the first set of diagnostic test values to cover a range,
order the normalized first set of diagnostic test values such that a low-frequency content plot is derived,
create a first equation describing the ordered data of the first patient data set for the normalized first set of diagnostic test values,
retrieve a second patient data set that corresponds to a second outcome,
select a second set of diagnostic test value from the second patient data set,
normalize the second set of diagnostic test values to cover a range,
order the normalized second set of diagnostic test values,
create a second equation describing the ordered data of the second patient data set for the normalized second set of diagnostic test values, and
compare the first and second equations.

10. The system of claim 9, wherein the instructions for causing the processing device to create the first equation describing the ordered data further comprise instructions for causing the processing device to plot the normalized first set of diagnostic test values.

11. The system of claim 10, wherein the instructions for causing the processing device to create the second equation describing the ordered data further comprise instructions for causing the processing device to plot the normalized second set of diagnostic test values.

12. The system of claim 11, wherein the instructions for causing the processing device to compare the first and second equations further comprise instructions for causing the processing device to:
plot the first equation and the second equation in a graph; and
display, on a display operably connected to the processing device, the graph.

13. The system of claim 10, further comprising instructions for causing the processing device to:
before plotting the normalized first set of diagnostic test values, stratify the first plurality of normalized diagnostic test results by removing patient data for a diagnostic test having a patient data that exceeds a threshold; and
adjust remaining patient data by an adjustment factor.

14. The system of claim 9, further comprising instructions for causing the processing device to determine a threshold value, wherein the threshold value is indicative of whether a patient is at high risk of suffering a severe event.

15. The system of claim 14, further comprising instructions for causing the processing device to compare a first risk score for the first patient against the threshold value.

16. The system of claim 15, wherein the first risk score is determined based upon an integration of an area of the first equation of the first patient data set.
